(19) United States
(12) Patent Application Publication
(10) Pub. No.: US 2019/0139149 A1
(43) Pub. Date: May 9, 2019

(54) SYSTEM AND METHOD FOR CONTENT REPORTING

(71) Applicant: Facebook, Inc., Menlo Park, CA (US)

(72) Inventors: Albert Charlie Hong, Mountain View, CA (US); Isaac Jushiang Chao, Milpitas, CA (US); Vishwanath Sarang, Sunnyvale, CA (US)

(21) Appl. No.: 15/803,618

(22) Filed: Nov. 3, 2017

(51) Int. Cl. G06Q 50/00; G06K 9/00

(52) U.S. Cl. CPC G06Q 50/01; G06F 17/2705; G06K 9/00288

(57) ABSTRACT

Methods, systems, computer-readable media, and apparatuses for content reporting are presented. In some embodiments, a computer system receives, from a first user, a request to report objectionable content within a social network system. In response to the request, the computer system causes one or more pages to be output to the first user. The computer system receives, from the first user, a first report comprising information input by the first user via the one or more pages, the information in the first report identifying particular content identified as objectionable by the first user and identifying a victim of the particular content. The computer system determines, based on the first report, whether the victim is to be identified as being victimized.

### BACKGROUND

With the increase of social networking sites, cyberbullying and harassment is on the increase. This type of abusive behavior is an issue within social networks and can leave users of the social network who are victimized by such content feeling disbelieved, vulnerable, and knock their self-esteem. Additionally, victims of cyberbullying or harassment may be less likely to use the social networking site in the future. Prior solutions do not offer the ability to provide the context of who the victim of the cyberbullying or harassment is. Rather, users of the social networking site could only report content containing cyberbullying or harassment posted on the social networking site without being able to specify who the abusive content is directed toward (e.g., who the victim is). The prior solution typically assumes that the user submitting the report is the victim of the abusive content, but this assumption is only correct in a small number of instances. As such, the prior solutions are ineffective and inaccurate.

### BRIEF SUMMARY

Certain embodiments are described that allow for content reporting within a social network system. In some embodiments, the content reporting may allow a first user (e.g., a reporter) to report content posted within the social network system as containing abusive content (e.g., bullying or harassing content) directed toward another user of the social network system (e.g., a victim). The first user (e.g., reporter) of the abusive content may be asked, within a user interface (UI) caused to be presented to the first user by the social network system, to specify who the victim of the abusive content is. The content reported as abusive content and the victim of the abusive content may be used to generate a review submission that can be reviewed by the social network system or one or more reviewers.

With knowledge of who the victim is, the social network system can more readily detect instances of abusive content among reported content which may increase accuracy and improve user satisfaction. This provides a number of benefits. For example, the social network system may differentiate actions to be taken based on who the victim is (e.g., reporter is victim, reporter's friend is victim, or general offensive content). Additionally, the content reporting allows for meaningful friction for reporting to give the social network system more actionable reports for which an action can be taken (e.g., removing the abusive content from the social network system). Moreover, the content reporting may also allow for stacking or grouping reports that include the same content and the same victim, thus reducing the number of review tasks required by the social network system while still serving the same number of users, thereby improving efficiency. For example, if three different users report the same piece of abusive content that targets the same victim, only one of those reports may need to be reviewed by social network system or the one or more reviewers prior to determining an action to be taken.

In some embodiments, with knowledge of who the victim is, a face matching feature may be employed. The face matching feature may be used to match known photos of the alleged victim (using facial recognition) with the abusive content to see if the abusive content in fact contains a photo of the victim.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method, including: receiving, by a computer system and from a first user, a request to report objectionable content within a social network system. The method also includes in response to the request, causing, by the computer system, one or more pages to be output to the first user. The method also includes receiving, by the computer system and from the first user, a first report including information input by the first user via the one or more pages, the information in the first report identifying particular content identified as objectionable by the first user and identifying a victim of the particular content. The method also includes determining, based on the first report, whether the victim is to be identified as being victimized. Other embodiments of this aspect include corresponding computer systems, apparatus, and computer programs recorded on one or more computer storage devices, each configured to perform the actions of the methods.

Implementations may include one or more of the following features. The method where the determining includes determining that the victim is victimized, where the method further includes: identifying an action to be performed, where the action affects accessibility of the particular content within the social network system. The method may also include performing the action. The method further including: determining that a second report, received from a second user, identifies the particular content as objectionable content and the victim of the particular content. The method may also include marking the first report and the second report as resolved upon performing the action. The method where the determining includes determining that the victim is not victimized, where the method further includes marking the first report as resolved. The method further including: determining that a second report, received from a second user, identifies the particular content as objectionable content and the victim of the particular content. The method may also include marking the second report as resolved upon determining that the victim is not victimized. The method where the victim is different from the first user. The method where the determining includes analyzing the particular content to identify whether the particular content contains an image of the victim based on one or more gathered images of the victim. Implementations of the described techniques may include hardware, a method or process, or computer software on a computer-accessible medium.

One general aspect includes a system, including: a processor; and a non-transitory computer readable medium coupled the processor, the computer readable medium including code, executable by the processor, for implementing a method including. The system also includes receiving, from a first user, a request to report objectionable content within a social network system. The system also includes in response to the request, causing one or more pages to be output to the first user. The system also includes receiving, from the first user, a first report including information input by the first user via the one or more pages, the information in the first report identifying particular content identified as objectionable by the first user and identifying a victim of the particular content. The system also includes determining, based on the first report, whether the victim is to be identified as being victimized. Other embodiments of this aspect include corresponding computer systems, apparatus, and computer programs recorded on one or more computer storage devices, each configured to perform the actions of the methods.

One general aspect includes one or more non-transitory computer-readable media storing computer-executable instructions that, when executed, cause one or more computing devices to: receive, from a first user, a request to report objectionable content within a social network system. The one or more non-transitory computer-readable media also includes in response to the request, cause one or more pages to be output to the first user. The one or more non-transitory computer-readable media also includes receive, from the first user, a first report including information input by the first user via the one or more pages, the information in the first report identifying particular content identified as objectionable by the first user and identifying a victim of the particular content. The one or more non-transitory computer-readable media also includes determine, based on the first report, whether the victim is to be identified as being victimized. Other embodiments of this aspect include corresponding computer systems, apparatus, and computer programs recorded on one or more computer storage devices, each configured to perform the actions of the methods.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of a survey network system, according to some embodiments.

FIG. 2 is a flowchart illustrating an exemplary process for content reporting, according to some embodiments.

FIG. 3 is a flowchart illustrating an exemplary process for stacking or grouping reports, according to some embodiments.

FIG. 4A illustrates an exemplary user interface for reporting abusive or offensive content, according to some embodiments.

FIG. 4B illustrates another exemplary user interface for reporting abusive or offensive content, according to some embodiments.

FIG. 5 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

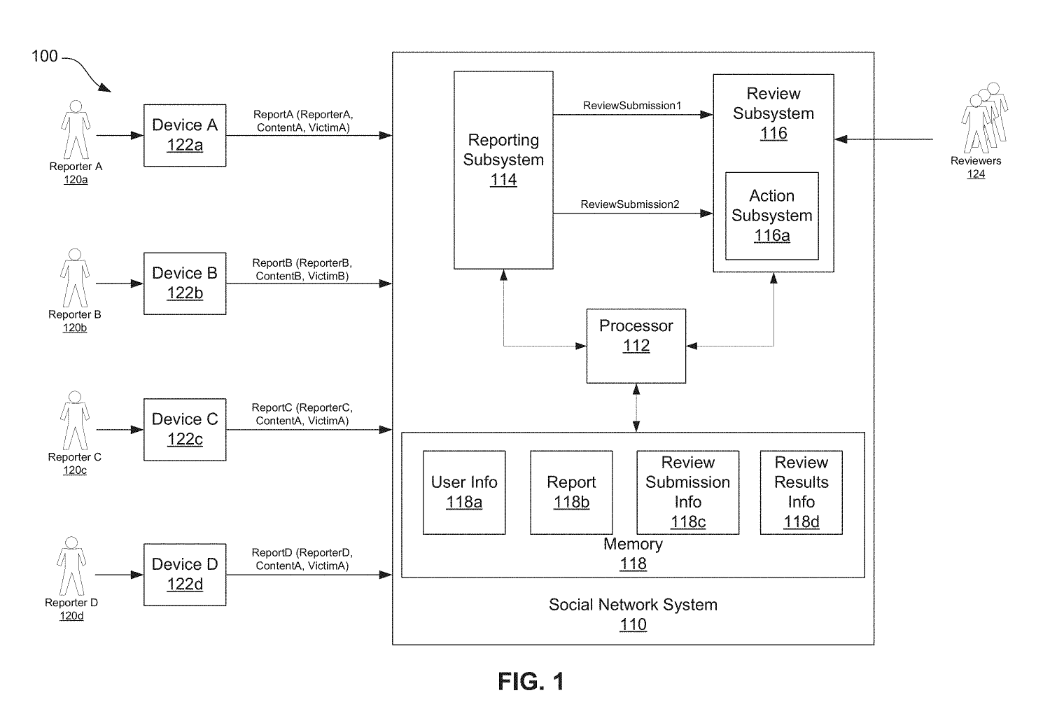

FIG. 1 illustrates a simplified diagram of a survey network system 110, according to some embodiments. The survey network system 110 includes a processor 112, reporting subsystem 114, review subsystem 116, and memory 118. The reporting subsystem 114, review subsystem 116, and memory 118 may all be coupled to the processor 112.

Processor 112 may be any general-purpose processor operable to carry out instructions on the survey network system 110. The processor 112 may execute the various applications and subsystems (e.g., reporting subsystem 114 and review subsystem 116) that are part of the social network system 110.

Reporting subsystem 114 may be configured to, when executed by processor 112, receive a request from a first user to report objectionable content within the social network system 110. In some embodiments, the objectionable content may be abusive content that can be classified as bullying or harassment toward a user of the social network system 110 or someone outside of the social network system 110. For example, reporter A 120a (e.g., first user), while accessing the social network system 110 via device A 122a, may come across content that the reporter A 120a finds to be abusive or objectionable. As a result, reporter A 120 may interact with a user interface (UI) of the social network system 110 displayed on device A 122a to begin the process of reporting the abusive or objectionable content. The reporting subsystem 144 may receive this request and in response to the request, cause one or more pages to be output to reporter A 120a via the UI displayed on device A 122a. The one or more pages may enable reporter A 120a to provide contextual information regarding the abusive or objectionable content. For example, reporter A 120a may be interact with the one or more pages to specify which content is abusive or objectionable, who the victim of the abusive or objectionable content is, why the content is considered to abusive or objectionable, etc. The contextual information regarding the abusive or objectionable content via the one or more pages presented to reporter A 120a may be referred to as a report received by the reporting subsystem 114. For example, report ReportA is received by the reporting subsystem 114 by reporter A 120a via device 122a. The report may identify at least the particular content identified as abusive objectionable by reporter A 120a and a victim of the particular content identified. The victim may be, for example, another user of the social network system 110. Similarly, ReportB, ReportC, and ReportD may be received by reporter B 120b, reporter C 120c, and reporter D 120d, respectively. The report(s) may be stored in a report database 118b within the memory 118.

Upon receiving the report from reporter A 120a (e.g., the first user), the reporting subsystem 114 may gather further information about the alleged victim. Information about the alleged victim may be retrieved from a user information database 118a stored within the memory 118. The user information database 118a may include any information about the victim that is known by the social network system 110. For example, the user information may include the victim's name, victim's username or user ID, victim's date of birth, victim's friend list, victim's photos, etc.

The reporting subsystem 114 may further analyze the abusive or offensive content. For example, if the abusive or offensive content is a photo, the reporting subsystem 114 may run a face matching algorithm on the abusive or offensive content against the alleged victim's own photos obtained from the user information database 118a, in order to determine whether the alleged victim actually appears in the abusive or offensive content. In another example, if the abusive or offensive content is a text post, the reporting subsystem 114 may parse an analyze the text post to determine whether any abusive or offensive words are present in the text post.

The reporting subsystem 114 may then generate a review submission based on the received report, gathered information about the alleged victim, and the analysis of the content. The review submission may contain the above information in addition to other information and may then be submitted to the review subsystem 116. For example, the reporting subsystem 114 may generate ReviewSubmission1 for ReportA (received from reporter A 120a via device A 122a) with the gathered victim information and analysis of the content. ReviewSubmission1 may then be submitted by the reporting subsystem 114 to review subsystem 116. Similarly, the reporting subsystem 114 may generate ReviewSubmission2 for ReportB (received from reporter B 120b via device B 122b) and submit it to review subsystem 116. ReviewSubmission2 may be a different review submission than ReviewSubmission 1 because ReportA differs from ReportB in that the identified victims and alleged abusive or offensive content are different (e.g., VictimA vs. VictimB and Content A vs. Content B).

In some embodiments, the reporting subsystem 114 may stack or group multiple received reports that contain the same victim and the same alleged abusive or offensive content together. For example, in FIG. 1, ReportA, ReportC, and ReportD are all reports containing ContentA and VictimA. In other words, these three reports contain the same alleged abusive or offensive content and the same victim. The reporting subsystem 114, upon receiving the three separate reports, may combine these reports into a single review submission. For example, reporting subsystem 114 may generate ReviewSubmission1 from received reports ReportA, ReportC, and ReportD. By stacking or grouping the reports that contain the same victim and alleged abusive or offensive content into a single review submission, less review submissions may need to be submitted to the review subsystem 116 resulting in improved efficiency for the review process.

Review subsystem 116 may be configured to, when executed by processor 112, receive one or more review submissions from the reporting subsystem 114. In some embodiments, the review subsystem 116 may store the received one or more review submissions in a review submission information database 118c within the memory 118. The review submission information database 118c may store some or all previously received review submissions from the reporting subsystem 114. The review submission information database 118c may also indicate a status for the received review submissions (e.g., whether the review submissions are pending, resolved, or need further action to be taken).

The review subsystem 116 may determine, or provide an interface for determining, whether the identified victim is the review submission is actually being victimized. This may be referred to as a review process. In some embodiments, the review process may be automated by the review subsystem 116, while in other embodiments the review process may be completed by one or more reviewers 124 of the social network system 110 manually by interfacing with the social network system.

For example, the review subsystem 116 may employ one or more algorithms or machine learning techniques to process a received review submission and determine whether the reported victim is actually being victimized. For example, this determination may be based on the information contained within the review submission such as the report, the gathered victim information, and the analysis of the alleged abusive or offensive content. In another example, the review subsystem 116 may cause the presentation of a user interface to be displayed on a device accessible by one or more manual reviewers 124. The manual reviewers 124 may be able to review the review submission on via the UI and manually make a determination about whether the victim is being victimized. The reviewer(s) may also be able to view, via the UI, the status of the review submission, individual reports that may have been stacked or grouped for the review submission, or any other information related to the review submission.

Upon determining the results of processing the review submission, the review subsystem 116 may take a further action on the abusive or offensive content, via the action subsystem 116a. The action subsystem 116a may be configured to, when executed by processor 112, execute one or more actions on the content. The actions can include, for example, removing the abusive or offensive content from the social network system, transmitted the abusive or offensive content to a third-party authority, or ignoring the abusive or offensive content. For example, if the result of the processing is that the victim is identified as being victimized, the review subsystem 116 may remove the abusive or offensive content from the social network system. In another example, if the abusive or offensive content is egregious, such as threats to the victim's well-being, the abusive or offensive content may be transmitted to an authority such as law enforcement. In yet another example, if the result of the processing is that the victim is not to be identified as a victim and the report has no merit, the content may be left alone. In some embodiments, these actions may also be performed manually by the one or more reviewers 124.

After an action is taken, the review subsystem 116 may update a status of the review submission. For example, after an action is taken, the review subsystem 116 may set the status of the review submission as resolved. In another example, if the review subsystem 116 is unable to perform an action on the content due to insufficient information, the review subsystem 116 may set the status of the review submission as needing further information or manual review.

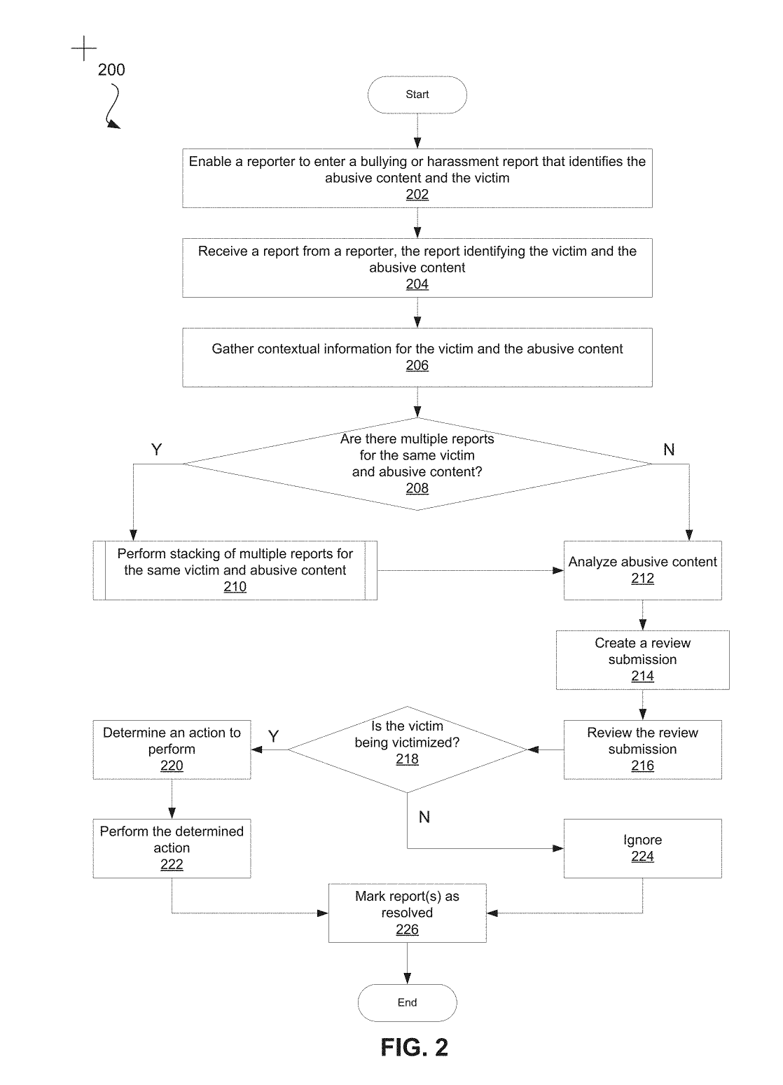

FIG. 2 is a flowchart 200 illustrating an exemplary process for content reporting, according to some embodiments. At step 202, the process may begin by enabling a reporter to enter a bullying or harassment report that identifies the abusive content and the victim. For example, the reporting subsystem 114 may cause one or more pages to be output to a first user via a UI displayed on a device belonging to the first user. The one or more pages may enable the first user to provide contextual information regarding the abusive or objectionable content along with the identity of the purported victim.

At step 204, after enabling the reporter to enter a bullying or harassment report that identifies the abusive content and the victim, a report from the reporter identifying the victim and the abusive content may be received. The report may be received by the reporting subsystem 114 via the device belonging to the first user (e.g., the reporter). For example, the reporting subsystem 114 may receive the report entered by reporter A 120a via device 122a. The report may contain the name of the reporter, the identity of the victim, and the abusive or offensive content. In some embodiments, multiple reports may be received by the reporting subsystem 114, each report containing the same identity of the victim and the same abusive or offensive content.

In some embodiments, a check may also be performed in step 204 regarding whether the reporter has reported the victim and the alleged abusive or offensive content before. If the reporter has reported the victim and the alleged abusive or offensive content before, the reporter may be denied the ability to submit another report with the same content and the same victim, to prevent multiple duplicate reports from the same reporter.

At step 206, after a report from the reporter identifying the victim and the abusive content is received, contextual information for the victim and the abusive or offensive content may be gathered. For example, information about the alleged victim may be retrieved from a user information database. The user information database may include any information about the victim that is known by the social network system 110. For example, the user information may include the victim's name, victim's username or user ID, victim's date of birth, victim's friend list, victim's photos, etc. The abusive or offensive content may also be analyzed.

At step 208, after contextual information for the victim and the abusive or offensive content is gathered, a determination is made whether multiple reports for the same victim and the same abusive or offensive content were received. If it is determined that multiple reports for the same victim and the same abusive or offensive content were received, the multiple reports may be stacked or grouped (step 210). For example, the reporting subsystem 114 may stack or group multiple received reports that contain the same victim and the same alleged abusive or offensive content together. However, if is determined that there are not multiple reports for the same victim and the same abusive or offensive content, the process may skip to step 212.

At step 212, after a determination is made whether multiple reports for the same victim and the same abusive or offensive content were received, the abusive content may be analyzed. For example, if the abusive or offensive content is a photo, the reporting subsystem 114 may run a face matching algorithm on the abusive or offensive content against the alleged victim's own photos obtained from the user information database 118a, in order to determine whether the alleged victim actually appears in the abusive or offensive content. In another example, if the abusive or offensive content is a text post, the reporting subsystem 114 may parse an analyze the text post to determine whether any abusive or offensive words are present in the text post.

At step 214, after the abusive or offensive content is analyzed, a review submission may be created. The review submission may be based on the received report, gathered information about the alleged victim, and the analysis of the content. The review submission may contain the above information in addition to other information. For example, referring back to FIG. 1, the reporting subsystem 114 may generate ReviewSubmission1 for ReportA (received from reporter A 120a via device A 122a) with the gathered victim information and analysis of the content. The generated review submission (e.g., ReviewSubmission1) may then be submitted to the review subsystem 116 for further processing.

At step 216, after the review submission is created, the review submission may be reviewed and processed. The review submission may be reviewed and processed in order to determine whether the identified victim is the review submission is actually being victimized (step 218). For example, the review subsystem 116 may employ one or more algorithms or machine learning techniques to process a received review submission and determine whether the reported victim is actually being victimized. This determination may be based on the information contained within the review submission such as the report, the gathered victim information, and the analysis of the alleged abusive or offensive content. For example, if it is determined that the victim's photo is present in the abusive or offensive content, and the content is in fact abusive or offensive, it may be determined that the victim is being victimized. In some embodiments, the review process may be manually completed by one or more reviewers in order to determine whether the victim is being victimized. If it is determined that the victim is being victimized, the process may continue to step 220. Otherwise, if it is determined that the victim is not being victimized, the process may continue to step 224 where the review submission is ignored and the process ends.

At step 220, after it is determined that the victim is being victimized, a determination regarding an action to perform may be made. The actions can include, for example, removing the abusive or offensive content from the social network system, transmitted the abusive or offensive content to a third-party authority, or ignoring the abusive or offensive content. For example, if the result of the processing is that the victim is identified as being victimized, the review subsystem 116 may remove the abusive or offensive content from the social network system. The determined action may be performed at step 222.

At step 226, after the determined action is performed, the report may be marked as resolved. A status indication associated with the report may be set to resolved and a timestamp of when the action was performed and which action was performed may be stored in the review results information database 118d. The report may be marked as resolved either after step 222 or step 224. In other words, the review may be marked as resolved regardless of whether an action was performed in step 220 because it was determined that the victim is being victimized or no action was performed in step 224 because it was determined that the victim is not being victimized. In some embodiments, multiple reports may be marked as resolved simultaneously if, for example, the reports were stacked or grouped together in a single review submission.

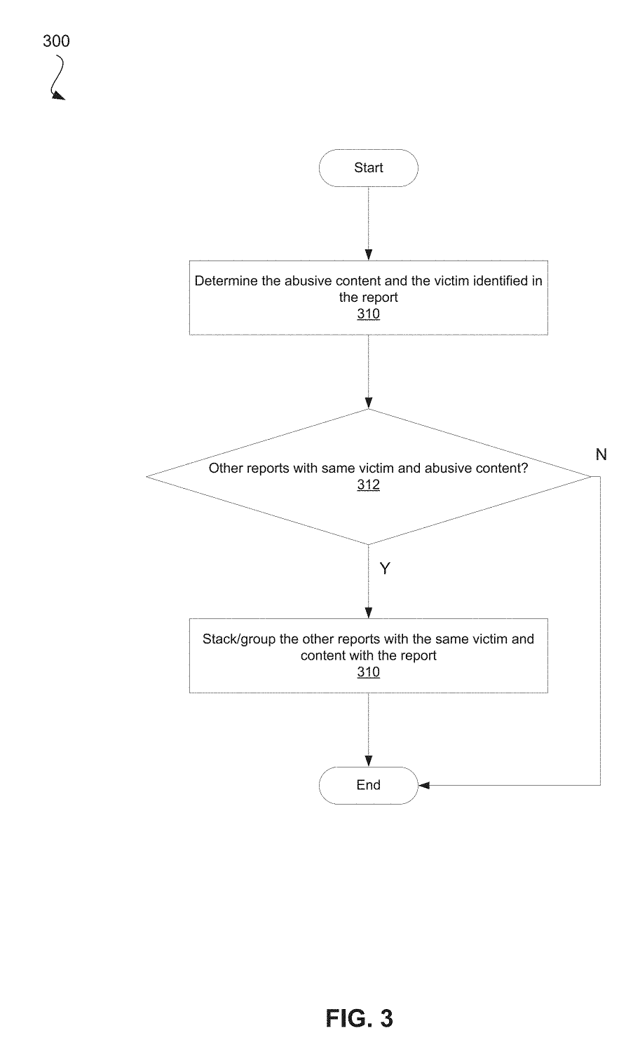

FIG. 3 is a flowchart illustrating an exemplary process 300 for stacking or grouping reports, according to some embodiments. Process 300 explains addition detail with respect to step 210 of FIG. 2.

At step 310, upon receiving a report from a reporter, the abusive of offensive content in the report and the identified victim may be determined. For example, the reporting subsystem 114 may receive a report from reporter A 120a via device 122a. The report may include the name of report A 120a, the content identified as being abusive or offensive, and an identity of the victim.

At step 312, after the abusive of offensive content in the report and the identified victim are determined, a determination may be made whether other reports containing the same victim and the same content have been received. In some embodiments, this step may be performed a predetermined time interval. For example, this step can be performed every hour, where at each hour the system analyzes reports received within the last hour. In another example, this may be performed once a day.

For example, in FIG. 1, ReportA, ReportC, and ReportD are all reports containing ContentA and VictimA. In other words, these three reports contain the same alleged abusive or offensive content and the same victim. Accordingly, the system may determine that other reports with the same victim and abusive content exist.

At step 314, after a determination is made that other reports containing the same victim and the same content have been received, the determined other reports may be stacked or grouped with the first report. For example, reporting subsystem 114 may generate ReviewSubmission1 from received reports ReportA, ReportC, and ReportD. By stacking or grouping the reports that contain the same victim and alleged abusive or offensive content into a single review submission, less review submissions may need to be submitted to the review subsystem 116 resulting in improved efficiency for the review process.

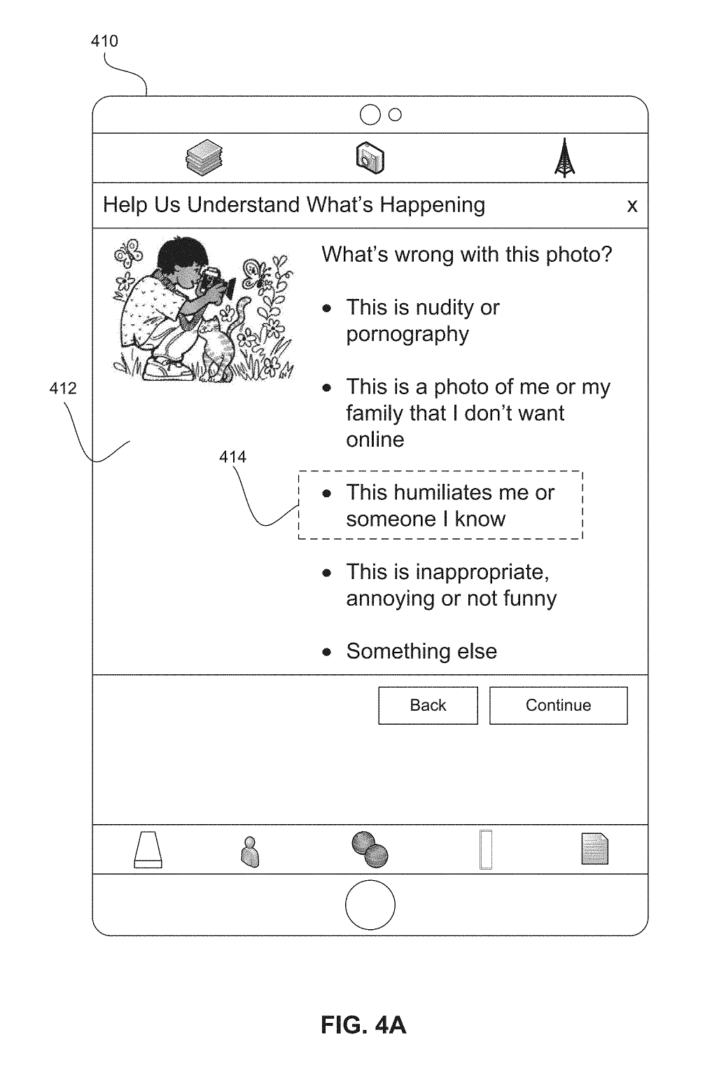

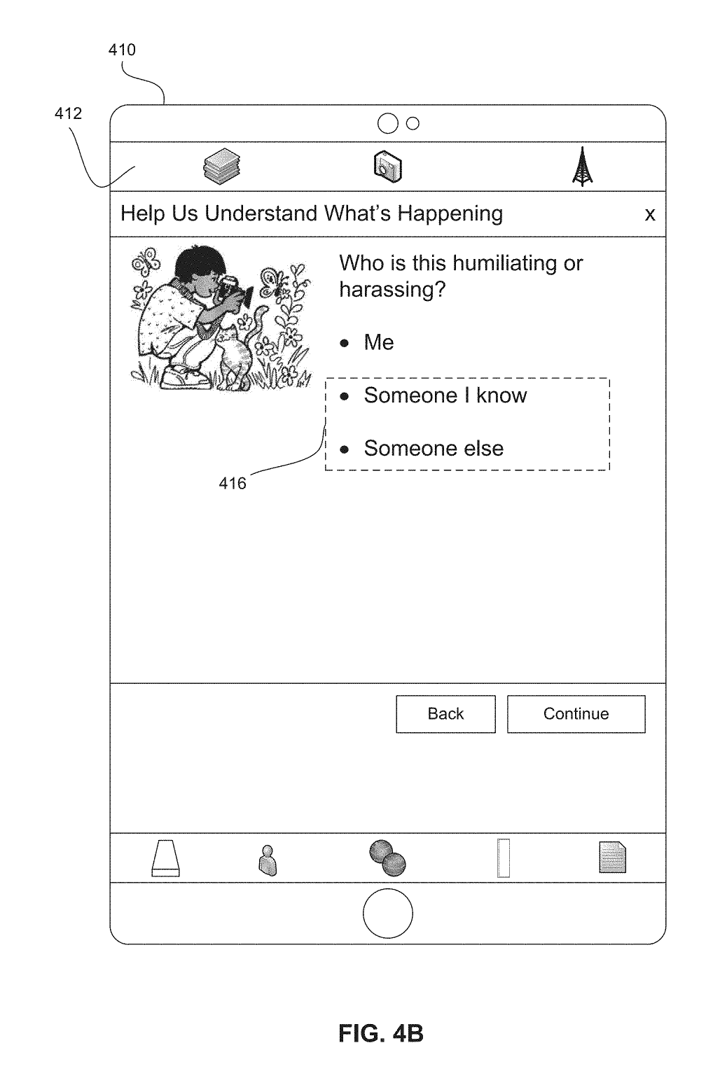

FIG. 4A illustrates an exemplary user interface 412 for reporting abusive or offensive content, according to some embodiments. The user interface may be displayed on a device 410, such as a smartphone. For example, device 410 may be any one of devices 122a, 122b, 122c, or 122d described with respect to FIG. 1. The content shown within user interface 412 may display to the user of the device 410 upon the user selecting an option within the UI to report abusive or offensive content within the social network system. For example, the user (e.g., reporter) of the device 410 may select a UI element shown with a social network application associated with the social network system. The UI element may contain some text informing the user that the user can report abusive or offensive content with the social network system by selecting the UI element. The UI element may be associated with a particular piece of content with the social network system. For example, the UI element may be a “Report” button that is displayed under each piece of content within the social network system.

Upon selecting the UI element, the user (e.g., reporter) may be presented with the user interface 412 shown in FIG. 4A. The user interface 412 may show an image or other representation of the content that the user has selected to report. In another example, if the content is text, the text may be displayed. The user interface 412 may also present a number of options to the user (e.g., reporter) for reporting the abusive or offensive content. For example, the user interface may ask the user for some context regarding the content (“What's wrong with this photo?”). As an example, the following options may be presented to the user: “This is nudity or pornography”; “This is a photo of me or my family that I don't want online; “This humiliates me or someone I know”; “This is inappropriate, annoying or not funny”; and “Something else.” In the case where the reporter wishes to report content where someone else is the victim, the reporter may select option 414 which indicates that the content humiliates the reporter or someone the reporter knows. Upon selecting the appropriate option, the reporter may select a UI element associated with continuing the process of reporting the content (e.g., a “Continue” button).

Referring now to FIG. 4B, after the user selects an option within the user interface 412 (e.g., option 414) the reporting user may be presented with further options to respond to a question requesting further the information from the user. For example, the user may not be presented with a question requesting who the target of the abusive or offensive content is. The user may be presented with the following options: “Someone I know”; and “Someone else.” In the case of the reporter reporting content that victimizes someone other than himself/herself, the reporter may select the “Someone else” option 416. By selecting this option, the reporter may be able to provide the context who the victim of the alleged abusive or offensive content is. The UI may also present further questions to the requestor along with further response options to gather further contextual information pertaining to the abusive or offensive content. The gathered information may be used by the reporting subsystem 114 in generating the review submission, as described above.

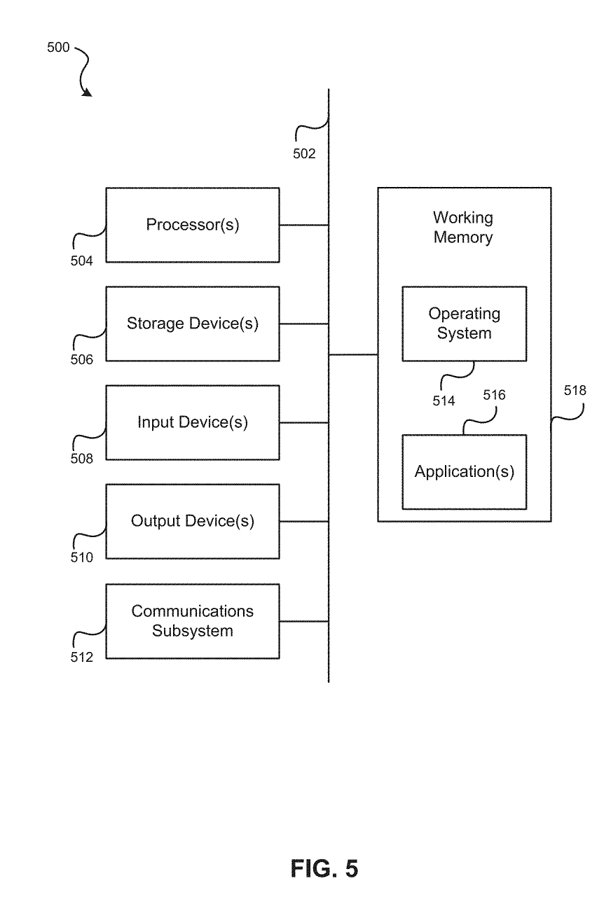

FIG. 5 illustrates an example of a computing system in which one or more embodiments may be implemented. A computer system as illustrated in FIG. 5 may be incorporated as part of the above described computerized device. For example, computer system 500 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 5 provides a schematic illustration of one embodiment of a computer system 500 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner. In some embodiments, elements computer system 500 may be used to implement functionality of the social network system 110 in FIG. 1.

The computer system 500 is shown comprising hardware elements that can be electrically coupled via a bus 502 (or may otherwise be in communication, as appropriate). The hardware elements may include one or more processors 504, including without limitation one or more general-purpose processors and/or one or more special-purpose processors (such as digital signal processing chips, graphics acceleration processors, and/or the like); one or more input devices 508, which can include without limitation one or more cameras, sensors, a mouse, a keyboard, a microphone configured to detect ultrasound or other sounds, and/or the like; and one or more output devices 510, which can include without limitation a display unit such as the device used in embodiments of the invention, a printer and/or the like.

In some implementations of the embodiments of the invention, various input devices 508 and output devices 510 may be embedded into interfaces such as display devices, tables, floors, walls, and window screens. Furthermore, input devices 508 and output devices 510 coupled to the processors may form multi-dimensional tracking systems.

The computer system 500 may further include (and/or be in communication with) one or more non-transitory storage devices 506, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 512, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 512 may permit data to be exchanged with a network, other computer systems, and/or any other devices described herein. In many embodiments, the computer system 500 will further comprise a non-transitory working memory 518, which can include a RAM or ROM device, as described above.

The computer system 500 also can comprise software elements, shown as being currently located within the working memory 518, including an operating system 514, device drivers, executable libraries, and/or other code, such as one or more application programs 516, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 506 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 500 may be omitted or may be implemented separate from the illustrated system. For example, the processor 504 and/or other elements may be implemented separate from the input device 508. In one embodiment, the processor is configured to receive images from one or more cameras that are separately implemented. In some embodiments, elements in addition to those illustrated in FIG. 5 may be included in the computer system 500.

Some embodiments may employ a computer system (such as the computer system 500) to perform methods in accordance with the disclosure. For example, some or all of the procedures of the described methods may be performed by the computer system 500 in response to processor 504 executing one or more sequences of one or more instructions (which might be incorporated into the operating system 514 and/or other code, such as an application program 516) contained in the working memory 518. Such instructions may be read into the working memory 518 from another computer-readable medium, such as one or more of the storage device(s) 506. Merely by way of example, execution of the sequences of instructions contained in the working memory 518 might cause the processor(s) 504 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 500, various computer-readable media might be involved in providing instructions/code to processor(s) 504 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 506. Volatile media include, without limitation, dynamic memory, such as the working memory 518. Transmission media include, without limitation, coaxial cables, copper wire and fiber optics, including the wires that comprise the bus 502, as well as the various components of the communications subsystem 512 (and/or the media by which the communications subsystem 512 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 504 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 512 (and/or components thereof) generally will receive the signals, and the bus 502 then might carry the signals (and/or the data, instructions, etc. carried by the signals) to the working memory 518, from which the processor(s) 504 retrieves and executes the instructions. The instructions received by the working memory 518 may optionally be stored on a non-transitory storage device 506 either before or after execution by the processor(s) 504.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 504—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method, comprising:
receiving, by a computer system and from a first user, a request to report objectionable content within a social network system;
in response to the request, causing, by the computer system, one or more pages to be output to the first user;
receiving, by the computer system and from the first user, a first report comprising information input by the first user via the one or more pages, the information in the first report identifying particular content identified as objectionable by the first user and identifying a victim of the particular content; and
determining, based on the first report, whether the victim is to be identified as being victimized.

2. The method of claim 1, wherein the determining comprises determining that the victim is victimized, wherein the method further comprises:
identifying an action to be performed, wherein the action affects accessibility of the particular content within the social network system; and
performing the action.

3. The method of claim 2, further comprising:
determining that a second report, received from a second user, identifies the particular content as objectionable content and the victim of the particular content; and
marking the first report and the second report as resolved upon performing the action.

4. The method of claim 1, wherein the determining comprises determining that the victim is not victimized, wherein the method further comprises marking the first report as resolved.

5. The method of claim 4, further comprising:
determining that a second report, received from a second user, identifies the particular content as objectionable content and the victim of the particular content; and
marking the second report as resolved upon determining that the victim is not victimized.

6. The method of claim 1, wherein the victim is different from the first user.

7. The method of claim 1, wherein the determining comprises analyzing the particular content to identify whether the particular content contains an image of the victim based on one or more gathered images of the victim.

8. A system, comprising:
a processor; and
a non-transitory computer readable medium coupled the processor, the computer readable medium comprising code, executable by the processor, for implementing a method comprising:
receiving, from a first user, a request to report objectionable content within a social network system;
in response to the request, causing one or more pages to be output to the first user;
receiving, from the first user, a first report comprising information input by the first user via the one or more pages, the information in the first report identifying particular content identified as objectionable by the first user and identifying a victim of the particular content; and
determining, based on the first report, whether the victim is to be identified as being victimized.

9. The system of claim 8, wherein the determining comprises determining that the victim is victimized, wherein the method further comprises:
identifying an action to be performed, wherein the action affects accessibility of the particular content within the social network system; and
performing the action.

10. The system of claim 9, wherein the method further comprises:
determining that a second report, received from a second user, identifies the particular content as objectionable content and the victim of the particular content; and
marking the first report and the second report as resolved upon performing the action.

11. The system of claim 8, wherein the determining comprises determining that the victim is not victimized, wherein the method further comprises marking the first report as resolved.

12. The system of claim 11, wherein the method further comprises:
determining that a second report, received from a second user, identifies the particular content as objectionable content and the victim of the particular content; and
marking the second report as resolved upon determining that the victim is not victimized.

13. The system of claim 8, wherein the victim is different from the first user.

14. The system of claim 8, wherein the determining comprises analyzing the particular content to identify whether the particular content contains an image of the victim based on one or more gathered images of the victim.

15. One or more non-transitory computer-readable media storing computer-executable instructions that, when executed, cause one or more computing devices to:
receive, from a first user, a request to report objectionable content within a social network system;
in response to the request, cause one or more pages to be output to the first user;
receive, from the first user, a first report comprising information input by the first user via the one or more pages, the information in the first report identifying particular content identified as objectionable by the first user and identifying a victim of the particular content; and
determine, based on the first report, whether the victim is to be identified as being victimized.

16. The one or more non-transitory computer-readable media of claim 15, wherein the determining comprises determining that the victim is victimized, wherein the computer-executable instructions, when executed, further cause the one or more computing devices to:
identify an action to be performed, wherein the action affects accessibility of the particular content within the social network system; and
perform the action.

17. The one or more non-transitory computer-readable media of claim 16, wherein the computer-executable instructions, when executed, further cause the one or more computing devices to:
determine that a second report, received from a second user, identifies the particular content as objectionable content and the victim of the particular content; and
mark the first report and the second report as resolved upon performing the action.

18. The one or more non-transitory computer-readable media of claim 15, wherein the determining comprises determining that the victim is not victimized, wherein the method further comprises marking the first report as resolved.

19. The one or more non-transitory computer-readable media of claim 18, wherein the computer-executable instructions, when executed, further cause the one or more computing devices to:
determine that a second report, received from a second user, identifies the particular content as objectionable content and the victim of the particular content; and
mark the second report as resolved upon determining that the victim is not victimized.

20. The one or more non-transitory computer-readable media of claim 15, wherein the determining comprises analyzing the particular content to identify whether the particular content contains an image of the victim based on one or more gathered images of the victim.
